(19) United States
(12) Patent Application Publication
(10) Pub. No.: US 2007/0244810 A1
(43) Pub. Date: Oct. 18, 2007

(54) ENABLING A SELECTABLE CHARITABLE DONATION AS AN INCENTIVE FOR A CUSTOMER TRANSACTION

(75) Inventor: Scott M. Rudolph, Seattle, WA (US)

Correspondence Address: DARBY & DARBY P.C., P.O. BOX 770, Church Street Station, New York, NY, 10008-0770, US

(73) Assignee: Altruism In Action LLC dba Giving Corps, Seattle, WA (US)

(21) Appl. No.: 11/692,170

(22) Filed: Mar. 27, 2007

Related U.S. Application Data
(60) Provisional application No. 60/767,434, filed on Mar. 27, 2006.

(51) Int. Cl. G06Q 40/00

(52) U.S. Cl. 705/39

(57) ABSTRACT

Enabling a user to identify a charitable entity to receive a donation and identify an amount of the donation to be provided for the successful performance of a transaction that provides a benefit to at least one third party. The user can select the charitable entity from a list of one or more entities provided by the third party, or provide information for a new/unlisted charitable entity. Furthermore, the amount of the donation can be increased by dynamic or static bidding by at least one third party that seeks to provide a further incentive for the successful completion of the transaction for the benefit of at least that third party. The user can operate as the third party that both benefits from the transaction and also provides the donation to the charitable entity. Also, the user can perform the beneficial transaction as a customer of the third party when the third party provides the donation to the charitable entity. Further, a ranking for the charitable donations can be provided to at least the customer that successfully completes the transaction.

This application claims priority to U.S. Provisional Patent Application Ser. No. 60/767,434 filed on Mar. 27, 2006.

### FIELD OF THE INVENTION

The present invention is directed to online philanthropy, and more particularly, enabling a selectable donation to a selectable charitable entity as an incentive for a customer transaction.

### BACKGROUND OF THE INVENTION

Consumer transactions for products and services online have grown significantly over the last several years. Often, a consumer makes the online transaction through a web portal or website. Typically, an operator and/or administrator has responsibility for maintaining the operability of the portal/website. For example, these responsibilities can include providing a virtual shopping cart that the customer can use to purchase products and/or services, fixing or removing broken hyperlinks, and generally promoting the portal/website through search engines, blog postings, and the like. However, many of the products and services sold on most websites are actually provided to the consumer by third party vendors and/or other affiliates of the operator. In many cases, the operator of the website works as a middle man between the consumer and several third party vendors/affiliates who carry the actual inventory and handle providing the product and/or service directly to the consumer.

In recent years, online philanthropy has become a popular way for customers that shop online to direct a predetermined amount and/or percentage of a transaction as a donation to one or more charities. Typically, an operator of the website that is offering a product and/or service for an online transaction chooses the amount/percentage of the donation and which charity/charities that the customer can direct this donation to. In the past, the consumer was provided with minimal, if any, ability to add or edit those charitable entities that receive donations for online philanthropy. Also, the third party vendors/affiliates have not been able to dynamically adjust the amount of the charitable donation in response to a particular consumer transaction request for a product and/or service.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description Of The Embodiments, which is to be read in association with the accompanying drawings, wherein:

FIG. 1 illustrates a diagram of one embodiment of an exemplary system in which the invention may be practiced;

FIG. 2 shows a schematic diagram of one embodiment of an exemplary mobile device;

FIG. 3 illustrates a schematic diagram of one embodiment of an exemplary network device;

FIG. 4A illustrates an exemplary user interface for enabling a customer to provide/select/ and/or identify information in various categories regarding a customer transaction associated with a donation to a charitable entity;

FIG. 4B illustrates an exemplary user interface for enabling a third party to at least provide/select/ and/or identify information in various categories regarding a customer transaction associated with a donation to a charitable entity;

FIG. 4C illustrates an exemplary user interface for displaying at least a ranking of information associated with a customer transaction linked to a donation for a charitable entity;

FIG. 5A illustrates a flow chart for enabling a customer to identify a charitable entity to receive a donation and identify an amount of the donation to be provided for the successful performance of a transaction that profits at least one third party;

FIG. 5B shows a flow chart for enabling a customer to arrange for an online transaction with a third party based at least in part on a donation to be provided to an identified charitable entity in response to completion of the transaction; and

FIG. 5C shows a flowchart for providing a charitable donation in response to completion of a survey or questionnaire by a customer, in accordance with the invention.

### DETAILED DESCRIPTION OF THE EMBODIMENTS

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated, the invention is directed to enabling a user to identify a charitable entity to receive a donation and identify an amount of the donation to be provided for the successful performance of a transaction that provides a benefit to at least one third party. The user can select the charitable entity from a list of one or more entities provided by the third party, or provide information for a new/unlisted charitable entity. Furthermore, the amount of the donation can be increased by dynamic or static bidding by at least one third party that seeks to provide a further incentive for the successful completion of the transaction for the benefit of at least that third party.

In at least one or more embodiments, the user can operate as the third party that both benefits from the transaction and also provides the donation to the charitable entity. Also, in at least one or more embodiments, the user can perform the beneficial transaction as a customer of the third party when the third party provides the donation to the charitable entity. Further, in at least one embodiment, the third party is an affiliate of an operator of a physical facility such as a store or and/or an online environment, e.g., a website or portal. The affiliate is introduced to the customer by the operator, and typically pays a commission, flat fee, or some combination of the two, to receive customer referrals from the operator.

Furthermore, in at least one or more embodiments, at least a portion of the invention is performed in an online environment. For example, the user could identify the charitable entity and the amount of the donation to the charitable entity on a website. Also, a customer could complete a transaction on the website for the benefit of a third party that sold the product/service/subscription to the customer. Additionally, in at least one or more embodiments, at least a portion of the invention is performed in a physical facility such as a store or office for enabling completion of the transaction by the customer. In still another embodiment, a kiosk can be provided to provide referrals to third parties that can complete customer transactions for particular products, services and/or subscriptions and also provide a charitable donation on behalf of the customer to an identified charitable entity.

In at least one or more embodiments, the customer transaction can include: purchasing a product, service, and/or subscription; redeeming a coupon for a product, service, and/or subscription; completing a survey; attending an event, promotion, presentation, and/or demonstration; voting in a prescribed manner for one or more candidates; or the like. Also, in at least one or more embodiments, the coupon can include a plurality of information, including, but not limited to, a location for the transaction to occur, the third party that is available to perform the transaction with, the charitable entity and the amount of the donation to be provided to the charitable entity in response to completion of the transaction, the cost of the transaction to the customer, any discounts in the cost of the transaction to be provided to the customer, or a time frame for the transaction to be performed.

Additionally, in at least one or more embodiments, the donation to the charitable entity can take one or more forms, either singly or in combination, including, but not limited to: money; credit; services; products; subscriptions; event tickets; coupons; presentations; or the like.

Furthermore, in at least one or more embodiments, the charitable entity can be an organization that is includes one or more of a religious organization, political organization, arts organization, social services organization, relief organization, foreign aid organization, health care organization, or the like. Also, the charitable entity might also represent one or more individuals that have one or more characteristics known to the user, e.g., politician, religious leader, artist, scholar, student, care giver, doctor, nurse, patient, victim, homemaker, refugee, friend, neighbor, family member, co-worker, or the like.

Additionally, in at least one or more embodiments, a ranking is provided to at least one of the customer, the third party that engages in the transaction with the customer, an operator of a website/portal that supports the interaction between the customer and the third party, or other third parties that bid on the transaction. The ranking can include the top third parties for providing donations to charitable entities, top customers to participate in the process, top charitable entities to receive donations from third parties, top donations to charitable donations for particular kinds of transactions, or the like. Also, the ranking can be provided directly by email, text message, instant message, alerts, or the like. Additionally, the rankings can be posted on a website, web portal, blog, chat room, or the like. Furthermore, the process can notify the charitable entity that the donation was provided on behalf of the customer.

In at least one or more embodiments, an online platform for enabling the invention can be arranged to operate as a system in one or more local or remote environments, including peer to peer, client-server, stand alone application, web based service, and/or the like. Also, the online platform can be accessed by users, customers, and third parties, with one or more different types of computing devices, including, but not limited to, personal computers, video game consoles, mobile telephones, smart watches, pagers, and/or personal digital assistants (PDA).

### Illustrative Operating Environment

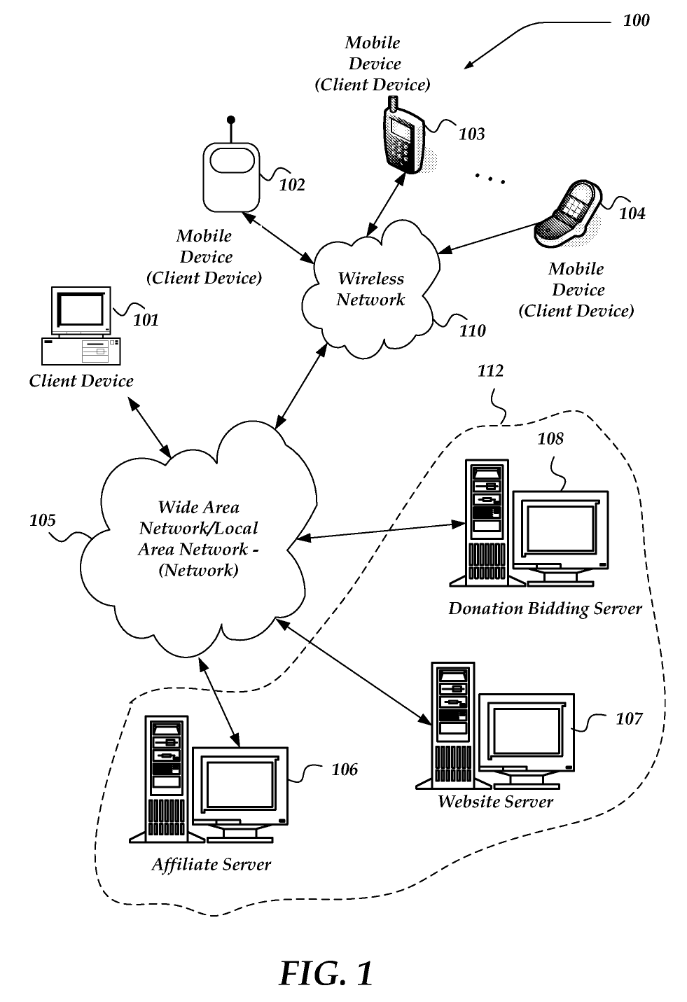

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, Affiliate Sever 106, Website Server 107, Donation Bidding Server 108, mobile (wireless) devices 102-104, and client device 101.

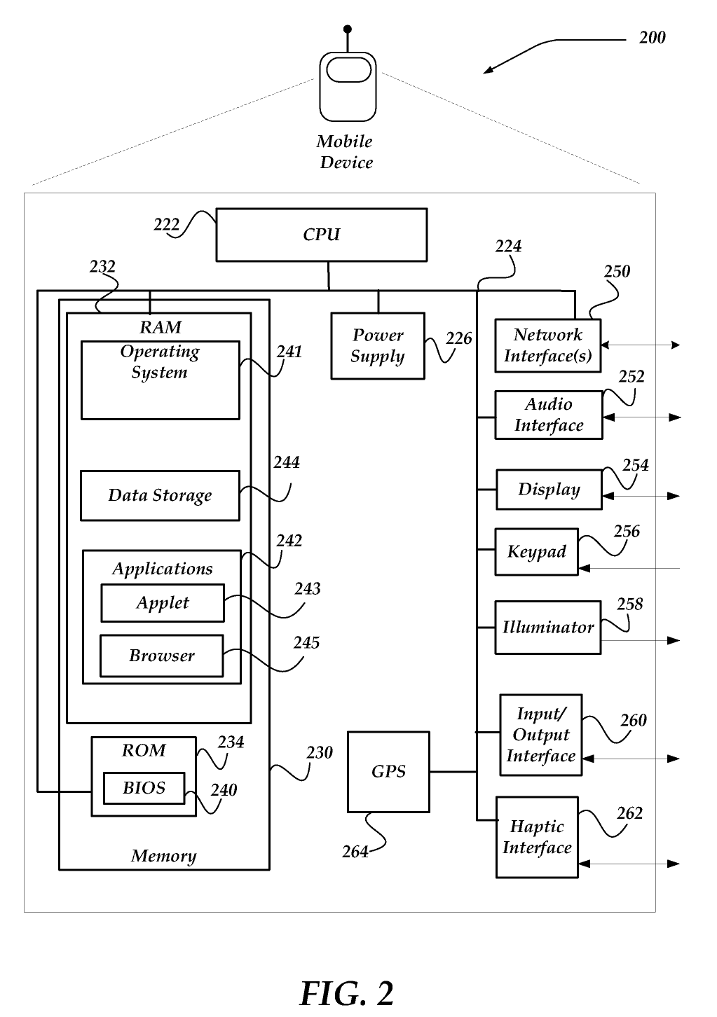

One embodiment of mobile devices 102-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Person al Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome display on which only text may be displayed. In another example, a web-enabled mobile device may have a touch sensitive screen, a stylus, and several lines of a color display in which both text and graphics may be displayed.

Mobile devices 102-104 may further be configured to include a client application that enables an end-user to log into a membership account on websitel 12 that includes servers 106, 107, and 108. Such an end-user membership account, for example, may be configured to enable one or more activities, including: enabling the member to send/receive messages with other members, non-members, and the platform administrator(s); access content on selected web pages; access chat rooms; access blogs; access reviews of products and services by industry experts and/or other members; purchase products and/or services; and try out available demonstrations for products/services prior to purchase. However, participation in at least some of these activities may also be performed without logging into the end-user membership account. Additionally, mobile devices 102-104 may also communicate with non-mobile (wired) client devices, such as client device 101, or the like.

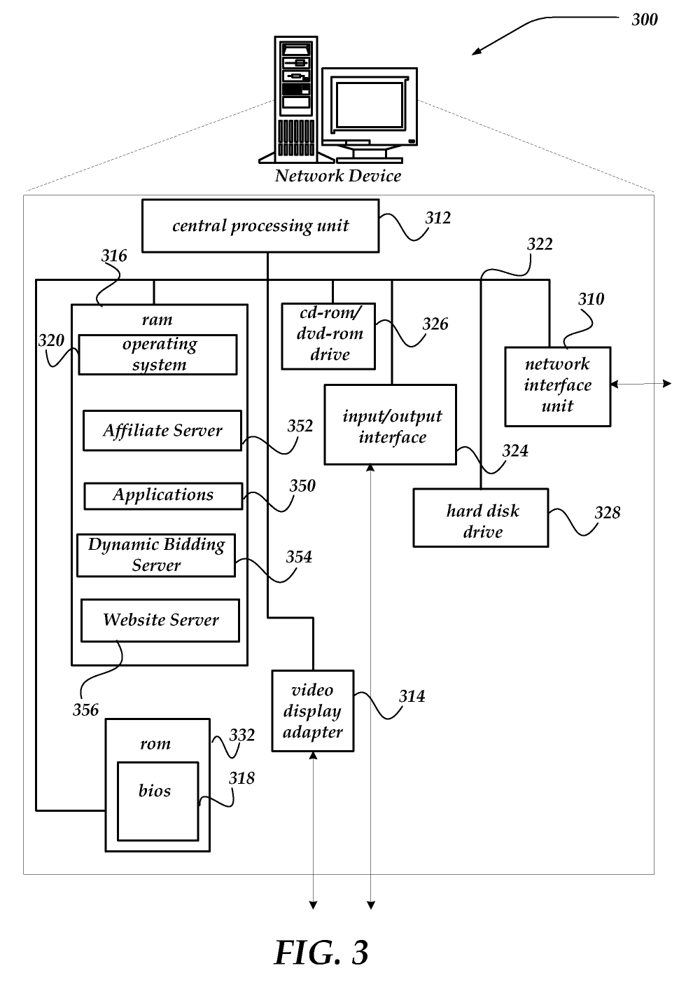

Client device 101 may include virtually any computing device capable of communicating over a network to send and receive information, such as network device 300 shown in FIG. 3, or the like. The set of such client devices may include devices that typically connect using a wired or wireless communications medium such as personal computers, multiprocessor systems, microprocessor-based or programmable consumer electronics, network PCs, or the like.

Wireless network 110 is configured to couple mobile devices 102-104 and its components with communication provided over network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further employ a plurality of access technologies including 2nd (2G), 3rd (3G), and 4^{th} (4G) generation radio access for cellular systems, WLAN, WiMax, Wireless Router (WR) mesh, and the like. Access technologies such as 2G, 3G, 3G, and future wireless access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), Universal Mobile Telephone System (UMTS), and the like. In essence, wireless network 110 may include virtually any wireless communication mechanism by which information may travel between mobile devices 102-104 and another computing device, network, and the like.

Network 105 is configured to couple platform 112 and its servers with other computing devices, including, mobile devices 102-104, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between platform 112, client device 101, and other computing devices.

Additionally, communication media typically embodies processor-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Platform 112 can also include a variety of services used to provide services to remotely located members. Such services include, but are not limited to web services, third-party services, audio services, video services, email services, IM services, SMS services, MMS services, VOIP services, video game services, blogs, chat rooms, gaming services, calendaring services, shopping services, photo services, or the like. Although FIG. 1 illustrates platform 112 including servers 106, 107, and 108 as physically separate computing devices, the invention is not so limited. For example, one or all of the servers can be operated on one computing device, without departing from the scope or spirit of the present invention. Also, devices that may operate as platform 112 include personal computers desktop computers, multiprocessor systems, microprocessor-based or programmable consumer electronics, network PCs, servers, and the like.

### Illustrative Mobile Device

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), Wide CDMA (CDMA), time division multiple access (TDMA), Universal Mobile Telephone Service (UMTS), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as processor readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, video games, gaming programs, search programs, shopping cart programs, and so forth. Applications 242 may further include browser 245. The browser application may be configured to receive and display graphics, text, multimedia, and the like, employing virtually any web based language, including a wireless application protocol messages (WAP), and the like. In one embodiment, the browser application for the mobile device is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display content and communicate messages.

Browser 245 may be configured to receive and enable a display of rendered content provided by platform 112. Further, browser 245 enables the user of mobile device 200 to select different actions displayed by the rendered content. In at least one embodiment, browser 245 enables the user to select one or more of a product to purchase, search for content and display the result, call another telephonic device, display and respond to messages, or the like.

### Illustrative Network Device

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, guest pass server 106, membership server 107, video game server 108, and/or client device 101 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of processor-readable storage media. Processor readable storage media may include volatile, nonvolatile, removable, and non-removable media implemented in any method or technology for storage of information, such as processor readable instructions, data structures, program modules, code, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed and read by a processor for a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Donation Bidding server 354, Website server 356, and Affiliate server 352 may also be included as an application program within applications 350. Also, Donation Bidding server 354, Website server 356, and Affiliate server 352 can be configured as a platform for providing transactions for products, services, and/or subscriptions linked to a selected donation to a selected charity.

### Illustrative User Interface

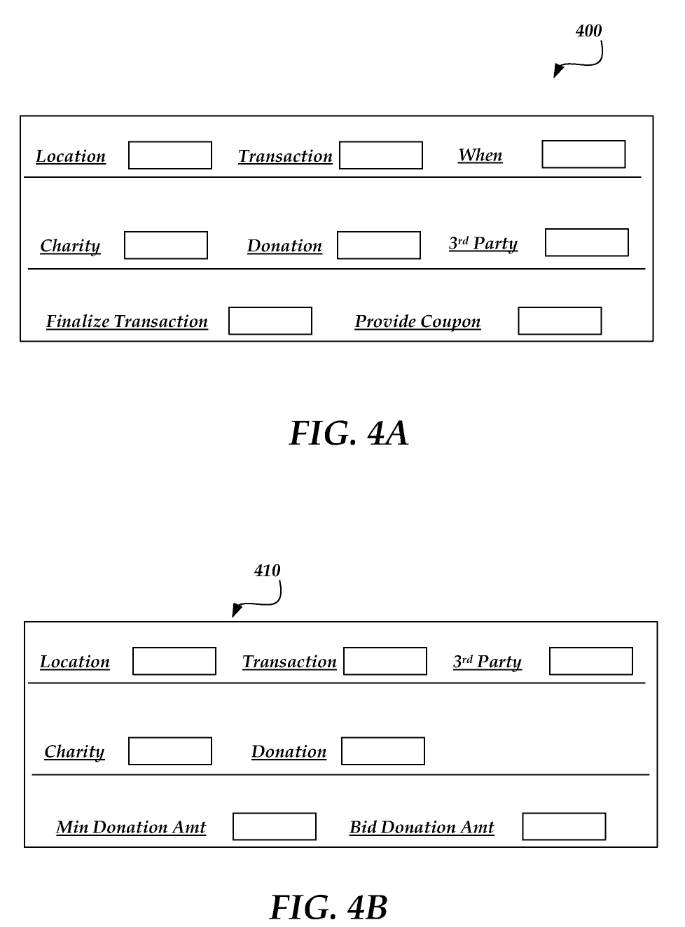

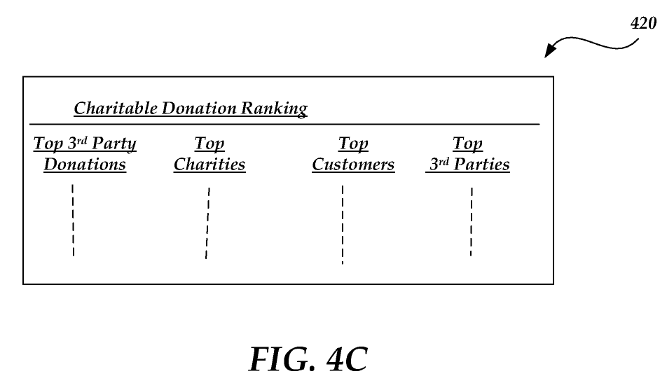

FIG. 4A illustrates exemplary user interface 400 for enabling a customer to at least provide/select/ and/or identify information in various categories regarding a customer transaction associated with a donation to a charitable entity. In at least one embodiment, the information for each category is dynamically linked so that as information is provided for each category, the remaining selectable categories are automatically updated. As shown, in one section of the user interface, the customer can provide or select location information, such as a zip code, neighborhood, city, state, time zone, and country. Also, the customer can provide or select the type of transaction to perform and when the transaction is likely to occur.

In another section of user interface 400, enables the customer to provide or select the charitable entity, amount and type of donation, and the third party to benefit from completion of the transaction. Also, in yet another section of user interface 400, the customer is enabled to finalize the transaction and/or generate a coupon for the completing the transaction.

FIG. 4B illustrates exemplary user interface 410 for enabling a third party to at least provide/select/ and/or identify information in various categories regarding a customer transaction associated with a donation to a charitable entity. In at least one embodiment, at least some of the information for each category is dynamically linked so that as information is provided for each category, the remaining selectable categories are automatically updated. As shown, one section of user interface 410 enables a third party to provide information regarding a type of customer transaction, location, and contact information for the third party. In another section, the third party can identify one or more charitable entities and one or more types and amounts of donation to offer as an incentive to the customer to select that particular third party for the customer transaction. In still another section, the third party can provide a minimum donation to a charitable entity for a particular customer transaction. Also, the third party can provide a bid amount for a donation to a charitable entity to gain the benefit of enabling the customer transaction. This bid can be provided either statically for a particular transaction, or dynamically in real time in competition with other third parties that would prefer to enable the customer transaction.

FIG. 4C illustrates exemplary user interface 420 for displaying at least a ranking of information associated with a customer transaction linked to a donation for a charitable entity. As shown, the user interface provides at least rankings of charitable entities, amounts donated to charitable entities, rankings of customers, rankings of third parties that provide the charitable donations, and the like.

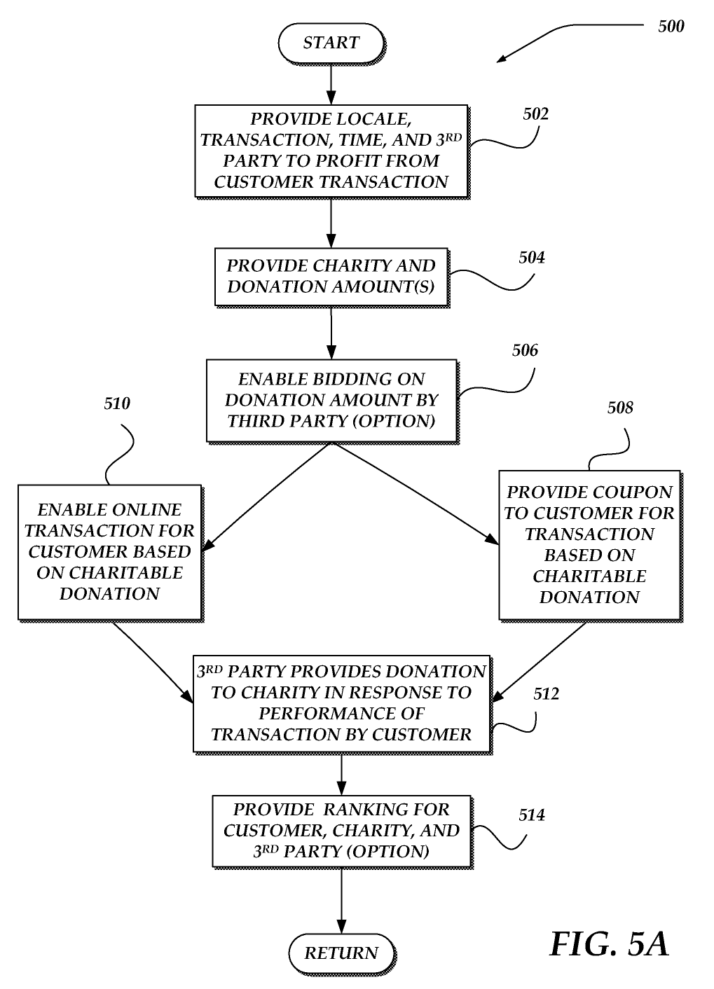

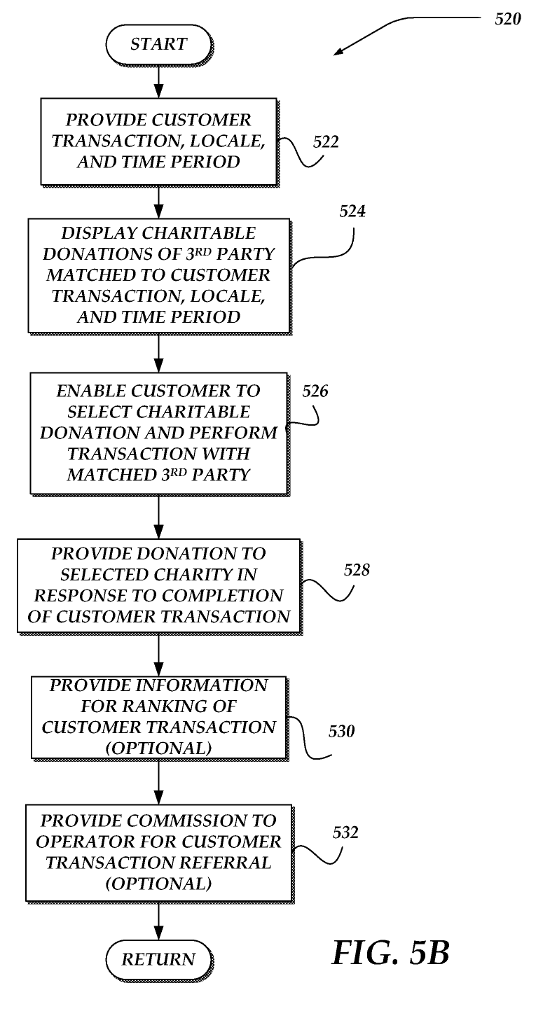

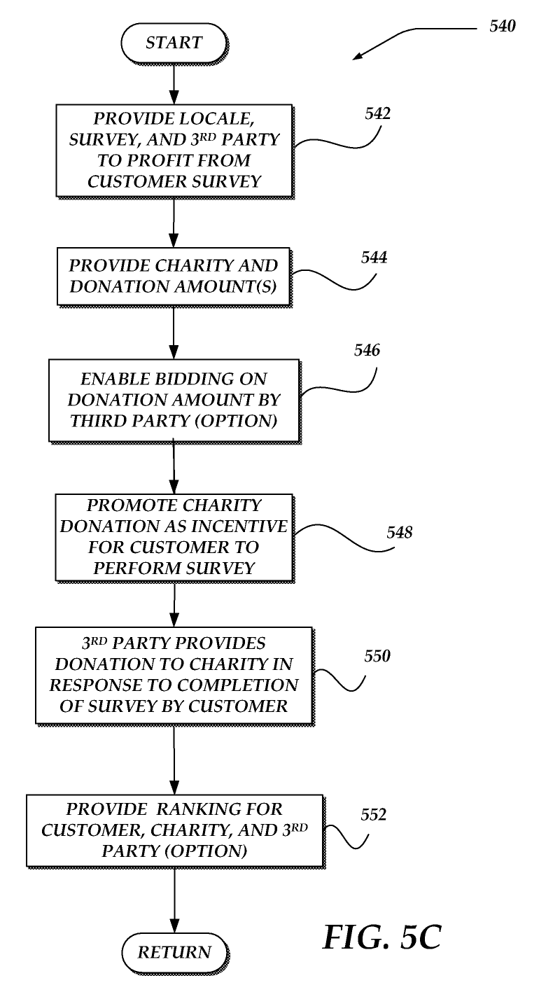

FIG. 5A illustrates a flow chart for process 500 for enabling a customer to identify a charitable entity to receive a donation for the successful performance of a transaction that provides a benefit to at least one third party. Moving from a start block, the process steps to block 502 where at least the location, type of transaction, and when (time) the transaction is likely to occur is provided. Optionally, one or more preferred third parties to enable and profit from the transaction can be provided also. Advancing to block 504, a charitable entity (charity) is selected to receive a donation amount that is provided by the third party that enables and profits from the completion of the transaction.

Stepping to block 506, bidding can be optionally enabled for one or more third parties to bid on the amount of the donation to be provided to the charitable entity. In at least one or more embodiments, at least a portion of the third parties capable of enabling the transaction can be enabled to bid on the amount of the donation to be provided to the charitable entity. Furthermore, in at least one or more embodiments, the bidding can be in the form of static/relatively/fixed bids that each third party submits, or the bidding can be dynamic where each third party submits bids against each other in real time for the highest amount of donation to be given to the charitable entity.

At block 508, a coupon can be provided to a customer as an incentive to complete the transaction with the third party. The coupon can indicate a plurality of information, including, but not limited to, the third party that is available to perform the transaction with, the charitable entity and the amount of the donation to be provided to the charitable entity in response to completion of the transaction, the cost of the transaction to the customer, any discounts in the cost of the transaction to be provided to the customer, or a time frame for the transaction to be performed. Additionally, or in the alternative, at block 510, an online interface for the customer to complete the transaction with the third party is provided.

Flowing to block 512, in response to the completion of the transaction by the customer with the third party, a donation is provided to the identified charitable entity. At block 514, a ranking is optionally provided to at least one of the customer, the third party that engages in the transaction with the customer, an operator of a website/portal that supports the interaction between the customer and the third party, or other third parties that bid on the transaction. The ranking can include the top third parties for providing donations to charitable entities, top customers to participate in the process, top charitable entities to receive donations from third parties, top donations to charitable donations for particular kinds of transactions. Also, the ranking can be provided directly by email, text message, alerts, or the like. Also, the rankings can be posted on a website, blog, chat room, or the like. Furthermore, the process can notify the charitable entity that the donation was provided on behalf of the customer. Next, the process returns to performing other actions.

FIG. 5B is a flow chart illustrating process 520 for enabling a customer to arrange for a transaction with a third party based at least in part on a donation amount to an identified charitable entity. Moving from a start block, the process flows to block 522 where the customer provides the transaction, locale and time period that the transaction is likely to occur. At block 524, a display is provided of charitable donations and corresponding third parties that are matched to enabling the completion of the customer's transaction for the particular locale and time period. Advancing to block 526, the customer selects the charitable entity to receive the donation and the corresponding third party to complete the transaction with. In at least one embodiment, a third party will enable the customer to chose the charitable entity from a list and/or provide a new unlisted charitable entity. Also, the customer can be also submit an amount of the charitable donation to the third party for approval, which can be a flat fee, percentage of transaction, or some combination of both.

At block 528, the donation is provided to the selected/identified charitable entity in response to the completion of the transaction between the customer and the third party. Advancing to block 530, information regarding the ranking of the customer transaction is optionally provided to at least one of the customer, third party, and/or operator. Optionally, at block 532, the third party also provides a commission as discussed above to the operator of the online environment. Next, the process returns to performing other actions.

FIG. 5C shows a flowchart for process 540 for providing a charitable donation in response to completion of a survey or questionnaire by a customer. Moving from a start block, the process flows to block 542 where a user provides the location, survey, and 3^{rd} party that seeks to benefit from the completion of the survey by a customer. Advancing to block 544, a charitable entity and a donation amount is provided by the user. Further, upon successful completion of the survey, it is indicated that the third party would make the donation to the charitable entity. At block 546, third parties that could benefit from completion of the survey can bid on the amount to donate to the charitable entity. The third party bidding can be static or dynamic and the parties can indicate minimum and maximum bids for the donation. Stepping to block 548, the donation amount to the charitable entity is promoted as an incentive to the customer to perform/complete the survey.

Flowing to block 550, the third party provides the donation to the charitable entity in response to the completion of the survey by the customer. At block 552, a ranking of the customer, charitable entity, and the third party is made available to one or more parties, e.g., the customer, charitable entity, or third party that benefit/bid on the survey. Next, the process returns to performing other actions.

It will be understood that each block of the above flowchart illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions executing on the processor provide steps for implementing the actions listed in the flowcharts discussed above.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed as new and desired to be protected by Letters Patent of the United States is:

1. A method for causing a charitable donation to be provided, comprising:
enabling a customer to identify a transaction to be performed at a particular locale during a time frame, wherein the performance of the transaction is a benefit to at least one of a plurality of third parties that is enabled to handle the transaction;
enabling the customer to identify a charitable entity and an amount of the donation to be provided to the charitable entity in response to the completion of the transaction; and
enabling the customer to select at least one of the plurality of third parties to handle the completion of the transaction, wherein the selected at least one of the plurality of third parties provides the donation to the identified charitable entity.

2. The method of claim 1, further comprising enabling the plurality of third parties to bid up the amount of the donation to the charitable entity, wherein the one of the plurality of third parties with the highest bid is identified for selection as the one of the plurality of third parties to handle the completion of the transaction.

3. The method of claim 2, wherein the bidding up of the amount of the donation is one of a static bid or a dynamic bid by at least one of the plurality of third parties.

4. The method of claim 1, further comprising providing a ranking of at least one of the customer, charitable entity, amount of the donation, or third party that is selected to complete the transaction with the customer.

5. The method of claim 1, further comprising providing a coupon for the customer to complete the transaction, wherein the coupon includes at least one of a location for the transaction to occur; at least one third party that is available to perform the transaction with the customer, an identifier for one or more charitable entities and the amount of the donation to be provided to the one or more charitable entities in response to completion of the transaction, the cost of the transaction to the customer, a discount in the cost of the transaction to be provided to the customer, or a time frame for the transaction to be performed.

6. The method of claim 1, wherein the donation is at least one of money, credit, service, product, subscription, event ticket, coupon, or presentation.

7. The method of claim 1, wherein the charitable entity includes at least one of a religious organization, political organization, arts organization, social services organization, relief organization, foreign aid organization, health care organization, or individual.

8. The method of claim 1, wherein the transaction is at least one of a purchase, lease, survey, questionnaire, presentation, demonstration, attendance at an event, or a vote for at least one of an individual, organization, product, service, or subscription.

9. The method of claim 1, further comprising enabling the method to be implemented with a plurality of executable data stored on a processor readable media.

10. A system for causing a charitable donation to be provided, comprising:
a server that includes:
a memory for storing processor executable data; and
a processor for executing the stored data to enable actions, including:
enabling a customer to identify a transaction to be performed at a particular locale during a time frame, wherein the performance of the transaction is a benefit to at least one of a plurality of third parties that is enabled to handle the transaction;
enabling the customer to identify a charitable entity and an amount of the donation to be provided to the charitable entity in response to the completion of the transaction; and
enabling the customer to select at least one of the plurality of third parties to handle the completion of the transaction, wherein the selected at least one of the plurality of third parties provides the donation to the identified charitable entity; and
a client for enabling the customer to interact with the server.

11. The system of claim 10, wherein the actions further comprise enabling the plurality of third parties to bid up the amount of the donation to the charitable entity, wherein the one of the plurality of third parties with the highest bid is identified for selection as the one of the plurality of third parties to handle the completion of the transaction.

12. The system of claim 11, wherein the bidding up of the amount of the donation is one of a static bid or a dynamic bid by at least one of the plurality of third parties.

13. The system of claim 10, wherein the actions further comprise providing a ranking of at least one of the customer, charitable entity, amount of the donation, or third party that is selected to complete the transaction with the customer.

14. The system of claim 10, wherein the actions further comprise providing a coupon for the customer to complete the transaction, wherein the coupon includes at least one of a location for the transaction to occur, at least one third party that is available to perform the transaction with the customer, an identifier for one or more charitable entities and the amount of the donation to be provided to the one or more charitable entities in response to completion of the transaction, the cost of the transaction to the customer, a discount in the cost of the transaction to be provided to the customer, or a time frame for the transaction to be performed.

15. The system of claim 10, wherein the donation is at least one of money, credit, service, product, subscription, event ticket, coupon, or presentation.

16. The system of claim 10, wherein the charitable entity includes at least one of a religious organization, political organization, arts organization, social services organization, relief organization, foreign aid organization, health care organization, or individual.

17. The system of claim 10, wherein the transaction is at least one of a purchase, lease, survey, questionnaire, presentation, demonstration, attendance at an event, or a vote for at least one of an individual, organization, product, service, or subscription.

18. An apparatus for causing a charitable donation to be provided, comprising:
a memory for storing processor executable data; and
a processor for executing the stored data to enable actions, including:
enabling a customer to identify a transaction to be performed at a particular locale during a time frame, wherein the performance of the transaction is a benefit to at least one of a plurality of third parties that is enabled to handle the transaction;
enabling the customer to identify a charitable entity and an amount of the donation to be provided to the charitable entity in response to the completion of the transaction; and
enabling the customer to select at least one of the plurality of third parties to handle the completion of the transaction, wherein the selected at least one of the plurality of third parties provides the donation to the identified charitable entity.

19. The apparatus of claim 18, wherein the actions further comprise enabling the plurality of third parties to bid up the amount of the donation to the charitable entity, wherein the one of the plurality of third parties with the highest bid is identified for selection as the one of the plurality of third parties to handle the completion of the transaction.

20. The apparatus of claim 18, wherein the apparatus is arranged as at least one of a network device, or a mobile device.
